(19) United States
(12) Patent Application Publication
(10) Pub. No.: US 2025/0233143 A1
(43) Pub. Date: Jul. 17, 2025

(54) ELECTRODE ACTIVE MATERIAL, ELECTRODE, AND BATTERY

(71) Applicant: Toyota Jidosha Kabushiki Kaisha, Toyota-shi (JP)

(72) Inventor: So YUBUCHI, Sunto-gun (JP)

(73) Assignee: Toyota Jidosha Kabushiki Kaisha, Toyota-shi (JP)

(21) Appl. No.: 19/007,751

(22) Filed: Jan. 2, 2025

(30) Foreign Application Priority Data
Jan. 16, 2024 (JP) 2024-004561

(51) Int. Cl. H01M 4/505; H01M 4/02

(52) U.S. Cl. CPC H01M 4/505; H01M 2004/028

(57) ABSTRACT

When a cross-section of an electrode active material of this disclosure is observed, relationships 2.30≤A2/A1≤44.00 and 0.50≤A3/A1≤1.90 are met. Here, A1 is an area ratio of an O2-type structure in the cross-section; A2 is an area ratio of an O6-type structure in the cross-section; and A3 is an area ratio of a T #2-type structure in the cross-section.

### CROSS-REFERENCE TO RELATED APPLICATION

This application claims priority to Japanese Patent Application No. 2024-004561 filed on Jan. 16, 2024, incorporated herein by reference in its entirety.

### BACKGROUND

### 1. Technical Field

This application discloses an electrode active material, an electrode, and a battery.

### 2. Description of Related Art

An active material for a battery having an O2-type structure (O: Octahedral) is known. As disclosed in Japanese Unexamined Patent Application Publications No. 2010-092824 (JP 2010-092824 A) and No. 2022-085829 (JP 2022-085829 A), an electrode active material having the O2-type structure is obtained by exchanging at least some of Na ions of a Na-containing oxide having a P2-type structure with Li ions.

### SUMMARY

Batteries using an electrode active material having the O2-type structure have room for improvement in terms of rate characteristics.

This application discloses the following several aspects as means for solving this problem.

### <Aspect 1>

An electrode active material, wherein the following relationships (1) and (2) are met when a cross-section of the electrode active material is observed:
2.30≤A2/A1≤44.00 (1); and
0.50≤A3/A1≤1.90(2), where:
A1: an area ratio of an O2-type structure in the cross-section;
A2: an area ratio of an O6-type structure in the cross-section; and
A3: an area ratio of a T #2-type structure in the cross-section.

### <Aspect 2>

The electrode active material of Aspect 1, wherein the electrode active material includes at least one of Ni, Mn, and Co as a constituent element.

### <Aspect 3>

The electrode active material of Aspect 2, wherein the electrode active material has a chemical composition represented by LiₐNa_{b}Mnₓ₋ₚNi_{y-q}Co_{z-r}M_{p+q+r}O₂ (where 0<a≤1.00, 0<b≤0.20, x+y+z=1, and 0≤p+q+r<0.17 hold true, and the element M is at least one type selected from B, Mg, Al, K, Ca, Ti, V. Cr, Fe, Cu, Zn, Ga, Ge, Sr, Y, Zr, Nb, Mo, and W).

### <Aspect 4>

An electrode including the electrode active material of any one of Aspects 1 to 3.

### <Aspect 5>

A battery having a positive electrode active material layer, an electrolyte layer, and a negative electrode active material layer, wherein the positive electrode active material layer includes the electrode active material of any one of Aspects 1 to 3.

The rate characteristics of a battery are likely to improve when the battery is configured using the electrode active material of this disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A shows one example of an O2-type structure;

FIG. 1B shows one example of an O6-type structure;

FIG. 1C shows one example of a T #2-type structure;

FIG. 2 schematically shows one example of the configuration of a battery;

FIG. 3A shows a result of an ACOM-STEM measurement for a cross-section of an electrode active material according to Example 1; and

FIG. 3B shows a result of an ACOM-STEM measurement for a cross-section of an electrode active material according to Comparative Example 1.

### DETAILED DESCRIPTION OF EMBODIMENTS

One embodiment of an electrode active material, an electrode, and a battery of this disclosure will be described below. However, the electrode active material, the electrode, and the battery of this disclosure are not limited to the embodiment described below.

### 1. Electrode Active Material

In the electrode active material according to one embodiment, the following relationships (1) and (2) are met when a cross-section of the electrode active material is observed:
2.30≤A2/A1≤44.00 (1); and
0.50≤A3/A1≤1.90 (2), where:
A1: an area ratio of an O2-type structure in the cross-section;
A2: an area ratio of an O6-type structure in the cross-section; and
A3: an area ratio of a T #2-type structure in the cross-section.

### 1.1 Crystal Structure

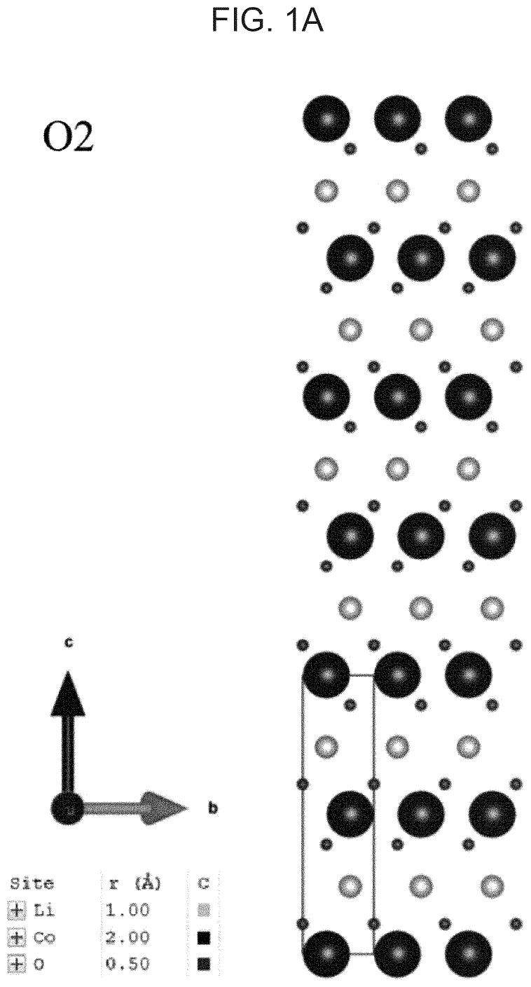

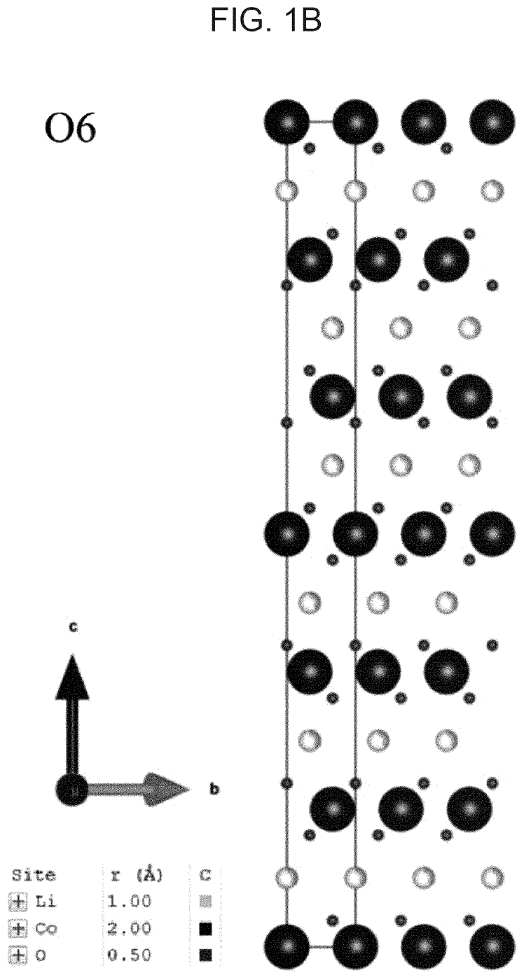

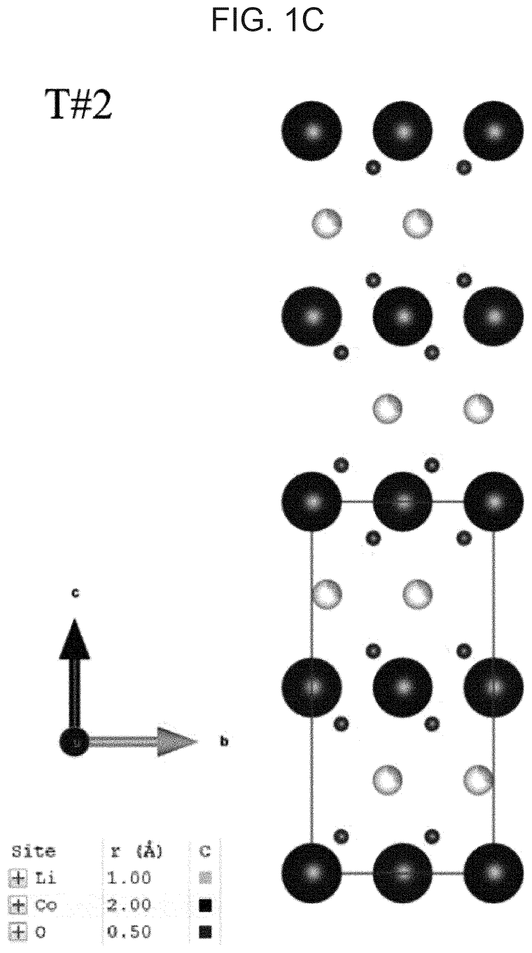

The electrode active material according to one embodiment has at least an O2-type structure, an O6-type structure, and a T #2-type structure as crystal structures. FIG. 1A shows one example of the O2-type structure; FIG. 1B shows one example of the O6-type structure; and FIG. 1C shows one example of the T #2-type structure. The O2-type structure belongs to the space group P63mc. The O6-type structure belongs to the space group R-3m. The T #2-type structure belongs to the space group Cmca. The electrode active material according to one embodiment is characterized by including these three crystal structures at a predetermined ratio.

It is important for the electrode active material according to one embodiment that the above relationships (1) and (2) are met when its cross-section is observed. Thus, in the cross-section of the electrode active material according to one embodiment, a predetermined amount of O6-type structure and a predetermined amount of T #2-type structure are present along with the O2-type structure. According to a new insight of the present inventor, an electrode active material including these three crystal structures at the ratio of the above relationships (1) and (2) has excellent rate characteristics. It is considered that a synergetic effect for charge-discharge reactions is exerted by interactions among these three crystal structures. Regarding the above relationship (1), A2/A1 is 2.30 or higher and 44.00 or lower, and may be 2.40 or higher, 2.50 or higher, 2.60 or higher, or 2.70 or higher, and may be 43.00 or lower, 42.00 or lower, 41.00 or lower, or 40.00 or lower. Regarding the above relationship (2), A3/A1 is 0.50 or higher and 1.90 or lower, and may be 0.60 or higher, 0.70 or higher, 0.80 or higher, 0.90 or higher, 1.00 or higher, or 1.10 or higher, and may be 1.85 or lower or 1.80 or lower.

The electrode active material according to one embodiment may have other crystal structures in addition to the O2-type structure, the O6-type structure, and the T #2-type structure. However, superior effects are likely to be exerted when the amount of the other crystal structures is as small as possible. For example, when a cross-section of the electrode active material according to one embodiment is observed, the total area ratio of the O2-type structure, the O6-type structure, and the T #2-type structure in that cross-section may be 80% or larger and 100% or smaller, 85% or larger and 100% or smaller, 90% or larger and 100% or smaller, 95% or larger and 100% or smaller, 97% or larger and 100% or smaller, or 99% or larger and 100% or smaller.

The “cross-section” of the electrode active material can be exposed by, for example, cutting a layer including the electrode active material. The “area ratio” of each crystal phase in the cross-section of the electrode active material can be determined by an ACOM-STEM measurement. Specifically, the area ratio of each crystal structure is calculated by acquiring an electron diffraction pattern at each measurement point in the cross-section by a precession electron diffraction method using JEM-2800 manufactured by JEOL Ltd., and indexing and calculating the crystal orientation so as to visualize a distribution of the crystal structures in the cross-section. Here, the beam diameter in this measurement should be about 1.5 nm. In this case, the O6-type structure having a large lattice constant is sometimes calculated as the O3-type structure that belongs to the same space group R-3m. On the other hand, the amounts of O3-type structure and O6-type structure included in the electrode active material can be determined beforehand by an XRD etc. Therefore, even if the electrode active material includes the O3-type structure, the area ratios of the O3-type structure and the O6-type structure can be determined by referring to the result of the XRD along with the result of the ACOM-STEM measurement.

### 1.2 Chemical Composition

The electrode active material according to one embodiment may include at least one of Ni, Mn, and Co as a constituent element. More specifically, the electrode active material according to one embodiment may include at least, as constituent elements, at least one of Mn, Ni, and Co, and Li and O. In particular, when the electrode active material includes at least Li, Mn, one or both of Ni and Co, and O as constituent elements, and particularly when the electrode active material includes at least Li, Mn, Ni, Co, and O as constituent elements, higher performance is likely to be achieved.

The electrode active material according to one embodiment may have a chemical composition represented by LiₐNa_{b}Mnₓ₋ₚNi_{y-q}Co_{z-r}M_{p+q+r}O₂ (where 0<a≤1.00, 0≤b≤0.20, x+y+z=1, and 0≤p+q+r<0.17 hold true, and the element M is at least one type selected from B, Mg, Al, K, Ca, Ti, V. Cr, Fe, Cu, Zn, Ga, Ge, Sr, Y, Zr, Nb, Mo, and W). When the electrode active material has such a chemical composition, a desired crystal structure is likely to be maintained. In the above chemical composition, the number of a is larger than 0 and may be 0.10 or larger, 0.20 or larger, 0.30 or larger, 0.40 or larger, 0.50 or larger, or 0.60 or larger, and is 1.00 or smaller and may be 0.90 or smaller, 0.80 or smaller, or 0.70 or smaller. In the above chemical composition, the number of b is 0 or larger and may be 0.01 or larger, 0.02 or larger, or 0.03 or larger, and is 0.20 or smaller and may be 0.15 or smaller or 0.10 or smaller. The number of x is 0 or larger and may be 0.10 or larger, 0.20 or larger, 0.30 or larger, 0.40 or larger, or 0.50 or larger, and is 1.00 or smaller and may be 0.90 or smaller, 0.80 or smaller, 0.70 or smaller, 0.60 or smaller, or 0.50 or smaller. The number of y is 0 or larger and may be 0.10 or larger or 0.20 or larger, and is 1.00 or smaller and may be 0.90 or smaller, 0.80 or smaller, 0.70 or smaller, 0.60 or smaller, 0.50 or smaller, 0.40 or smaller, 0.30 or smaller, or 0.20 or smaller. The number of z is 0 or larger and may be 0.10 or larger, 0.20 or larger, or 0.30 or larger, and is 1.00 or smaller and may be 0.90 or smaller, 0.80 or smaller, 0.70 or smaller, 0.60 or smaller, 0.50 or smaller, 0.40 or smaller, or 0.30 or smaller. The element M contributes only a little to charging and discharging. In this respect, a high charging-discharging capacity is likely to be secured when the number of p+q+r is smaller than 0.17 in the above chemical composition. The number of p+q+r may be 0.16 or smaller, 0.15 or smaller, 0.14 or smaller, 0.13 or smaller, 0.12 or smaller, 0.11 or smaller, or 0.10 or smaller. On the other hand, when the element M is included, a desired crystal structure is likely to stabilize. In the above chemical composition, the number of p+q+r is 0 or larger and may be 0.01 or larger, 0.02 or larger, 0.03 or larger, 0.04 or larger, 0.05 or larger, 0.06 or larger, 0.07 or larger, 0.08 or larger, 0.09 or lager, or 0.10 or larger. While the number of the components of O is almost 2, it is not limited to exact 2.0 and is indefinite.

### 1.3 Others

As will be described later, the electrode active material according to one embodiment can be obtained by replacing Na ions of a Na-containing oxide having a P2-type structure with Li ions. Here, the P2-type structure is a hexagonal system, in which the diffusion coefficient of Na ions is high and crystals tend to grow in a specific direction. In particular, when at least one of Mn, Ni, and Co is included as a transition metal element constituting part of the P2-type structure, crystals tend to grow in a specific direction into a plate shape. Therefore, a Na-containing oxide having the P2-type structure is usually plate-shaped particles having a high aspect ratio with the crystal growth direction biased toward a specific direction. The electrode active material may be obtained based on such plate-shaped Na-containing oxide particles, or may be obtained based on spherical Na-containing oxide particles. Thus, as to its shape, the electrode active material may be plate-shaped particles or may be spherical particles. When the electrode active material is spherical particles, as the crystallite size is reduced, the reaction resistance decreases, which is likely to lead to lower diffusion resistance inside the particles. Further, it is considered that when the electrode active material is applied to a battery, the tortuosity factor is reduced due to the spherical shape, leading to lower lithium-ion conduction resistance. As a result, for example, the rate characteristics are likely to further improve, and the reversible capacity is likely to increase. In this application, a “spherical particle” means a particle of which the degree of circularity is 0.80 or higher. The degree of circularity of the particle may be 0.81 or higher, 0.82 or higher, 0.83 or higher, 0.84 or higher, 0.85 or higher, 0.86 or higher, 0.87 or higher, 0.88 or higher, 0.89 or higher, or 0.90 or higher. The degree of circularity of the particle is defined by 4πS/L². Here, S represents an orthographic projection area of the particle, and L represents a perimeter of an orthographic projection image of the particle. The degree of circularity of the particle can be obtained by observing the external appearance of the particle using a scanning electron microscope (SEM), a transmission electron microscope (TEM), or an optical microscope.

The electrode active material according to one embodiment may be, for example, solid particles, or may be hollow particles, or may be particles having voids. While the size of particles of the electrode active material is not particularly limited, a smaller size is considered to be more advantageous. For example, an average particle diameter (D50) of the particles of the electrode active material may be 0.1 μm or larger and 10 μm or smaller, 1.0 μm or larger and 8.0 μm or smaller, or 2.0 μm or larger and 6.0 μm or smaller. The average particle diameter (D50) is a particle diameter at an integrated value 50% (D50, a median diameter) in a particle size distribution on a volume basis obtained by a laser diffraction-scattering method.

### 2. Manufacturing Method of Electrode Active Material

An electrode active material 1 can be manufactured by, for example, the following method. Specifically, the manufacturing method of the electrode active material according to one embodiment may include:
S1: Obtaining a transition metal oxide containing Na having the P2-type structure; and
S2: Exchanging at least some of Na ions of the Na-containing oxide with Li ions by ion exchange to obtain a Li-containing oxide having the O2-type structure, the O6-type structure, and the T #2-type structure.

### 2.1 S1

In S1, the transition metal oxide containing Na having the P2-type structure can be manufactured, for example, by going through the following:
S11: Obtaining a precursor (e.g., a precursor including at least one element among Mn, Ni, and Co);
S12: Covering the surface of the precursor with a Na source to obtain a composite body; and
S13: Firing the composite body.

Here, S13 may include:
S13-1: Subjecting the composite body to preliminary firing at a temperature of 300° C. or higher and lower than 700° C. for two hours or longer and ten hours or shorter;
S13-2: Continuously from the preliminary firing, subjecting the composite body to main firing at a temperature of 700° C. or higher and 1100° C. or lower for 30 minutes or longer and 48 hours or shorter, and
S13-3: Continuously from the main firing, subjecting the composite body to rapid cooling from a temperature T₁ of 200° C. or higher to a temperature T₂ of 100° C. or lower.

### 2.1.1 Production of Precursor

The precursor may be one that includes at least Mn and one or both of Ni and Co, or may be one that includes at least Mn, Ni, and Co. The precursor may be salt including at least one element among Mn, Ni, and Co. For example, the precursor may be at least one type among carbonate, sulfate, nitrate, and acetate. Or the precursor may be a compound other than salt. For example, the precursor may be hydroxide. The precursor may be hydrate. The precursor may be a combination of a plurality of types of compounds. The precursor may have various shapes. For example, the precursor may have a particulate shape, or may be spherical particles as will be described later. The particle diameter of the particles formed by the precursor is not particularly limited. By adjusting the particle diameter of the particles formed by the precursor and adjusting the manufacturing conditions of the composite body and the firing conditions of the composite body to be described later, the ratios of crystal phases included in the electrode active material that is finally obtained can be controlled.

In S11, an ion source that can form a precipitate with transition metal ions in an aqueous solution, and a transition metal compound including at least one element among Mn, Ni, and Co may be used, and a precipitate as the above-described precursor may be obtained by a coprecipitation method. Thus, spherical particles as the precursor are likely to be obtained. The “ion source that can form a precipitate with transition metal ions in an aqueous solution” may be, for example, at least one type selected from sodium salt, such as sodium carbonate or sodium nitrate, sodium hydrate, and sodium oxide. The transition metal compound may be the aforementioned salt, hydroxide, etc. that includes at least one element among Mn, Ni, and Co. Specifically, in S11, a precipitate as the precursor may be obtained by turning each of the ion source and the transition metal compound into a solution, and dripping and mixing together these solutions. In this case, as a solvent, for example, water is used. In this case, as a base, various sodium compounds can be used, and an aqueous solution of ammonia etc. may be added to adjust the basicity. In the case of the coprecipitation method, a precipitate as the precursor can be obtained by, for example, preparing an aqueous solution of a transition metal compound and an aqueous solution of sodium carbonate and dripping and mixing together these aqueous solutions. Or it is also possible to obtain the precursor by a sol-gel method. In particular, the coprecipitation method is likely to be able to produce spherical particles as the precursor.

In S11, the precursor may include an element M. The element M is at least one type selected from B, Mg, Al, K, Ca, Ti, V. Cr, Cu, Zn, Ga, Ge, Sr, Y, Zr, Nb, Mo, and W. These elements M function to, for example, stabilize the P2-type structure or the O2-type structure. The method of obtaining the precursor including the element M is not particularly limited. In the case where the precursor is obtained by the coprecipitation method in S11, the precursor including the element M in addition to at least one element among Mn, Ni, and Co can be obtained by, for example, preparing an aqueous solution of a transition metal compound including at least one of Mn, Ni, and Co, an aqueous solution of sodium carbonate, and an aqueous solution of a compound of the element M, and dripping and mixing together these aqueous solutions. Or in the manufacturing method of this disclosure, without the element M being added in S11, the element M may be doped when Na doping firing is performed in S2 and S3 to be described later.

### 2.1.2 Production of Composite Body

In S12, the surface of the precursor obtained by S11 is covered with a Na source to obtain a composite body. The Na source may be salt including Na, such as carbonate or nitrate, or may be a compound other than salt, such as sodium oxide or sodium hydroxide. In S12, the amount of the Na source to cover the surface of the precursor can be determined taking into account an amount of Na that is lost during firing afterward. In S12, a coverage ratio of the Na source on the surface of the precursor is not particularly limited. In S12, the method of covering the surface of the above-described precursor with the Na source is not particularly limited. For example, the precursor and the Na source may be mixed together by a mortar or a mixing device, or a solution including the Na source may be brought into contact with the precursor using a rolling fluidized coating method or a spray drying method and then dried. In particular, when the surface of the precursor is covered with the Na source by the spray drying method, the coverage ratio of the Na source on the surface of the precursor increases, which helps more appropriately adjust the crystallizability and the shape (plate-shaped particles or spherical particles) of a P2-type Na-containing oxide obtained by S13 to be described later, as well as allows more appropriate control of the ratio of each crystal structure included in the electrode active material that is finally obtained.

In S12, the precursor may be covered with an M source in addition to the Na source. For example, in S12, the composite body may be obtained by mixing together the precursor obtained by S11, the Na source, and the M source including at least one type of element M selected from B, Mg, Al, K, Ca, Ti, V, Cr, Cu, Zn, Ga, Ge, Sr, Y, Zr, Nb, Mo, and W. The M source may be, for example, salt including the element M, such as carbonate or nitrate, or may be a compound other than salt, such as oxide or hydroxide. The amount of the M source relative to the precursor can be determined according to the chemical composition of the Na-containing oxide after firing.

### 2.1.3 Firing of Composite Body

In S13, the composite body obtained by S12 is fired to obtain a Na-containing oxide having the P2-type structure. S13 may include the above-described S13-1, S13-2, and S13-3. By adjusting the firing conditions in S13-1, S13-2, and S13-3 in addition to the manufacturing conditions of the precursor and the manufacturing conditions of the composite body described above, the crystallizability and the shape (plate-shaped particles or spherical particles) of the P2-type Na-containing oxide obtained by S13 can be adjusted, as well as the ratio of each crystal structure included in the electrode active material that is finally obtained can be controlled.

In S13-1, the above-described composite body is subjected to preliminary firing at a temperature of 300° C. or higher and lower than 700° C. for two hours or longer and ten hours or shorter. In S13-1, the preliminary firing may be performed after the above-described composite body is arbitrarily shaped. The preliminary firing is performed at a temperature lower than that of main firing. If the preliminary firing in S13-1 is insufficient, formation of a P2 phase may become insufficient in the Na-containing oxide that is finally obtained. In S13-1, when the preliminary firing temperature is 300° C. or higher and lower than 700° C. and the preliminary firing time is two hours or longer and ten hours or shorter, sufficient preliminary firing can be performed on the composite body, so that thermal uniformity is enhanced, and the Na-containing oxide obtained by going through S13-2 and S13-3, to be described later, is likely to become an appropriate one. The preliminary firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The preliminary firing time may be two hours or longer and eight hours or shorter, three hours or longer and eight hours or shorter, four hours or longer and eight hours or shorter, five hours or longer and eight hours or shorter, or five hours or longer and seven hours or shorter. The preliminary firing atmosphere is not particularly limited, and may be, for example, an oxygen-containing atmosphere.

In S13-2, continuously from the above-described preliminary firing, the above-described composite body is subjected to the main firing at a temperature of 700° C. or higher and 1100° C. or lower for 30 minutes or longer and 48 hours or shorter. In S13-2, the main firing temperature of the composite body may be 800° C. or higher and 1000° C. or lower. If the main firing temperature is too low, the P2 phase does not form, and if the main firing temperature is too high, an O3 phase etc. instead of the P2 phase is likely to form. The temperature raising condition from the preliminary firing temperature to the main firing temperature is not particularly limited. In S13-2, the shape of the Na-containing oxide can be controlled by the main firing time. If the main firing time is too short, the formation of the P2 phase becomes insufficient. On the other hand, if the main firing time is too long, the P2-phase grows excessively, and the particles are likely to coarsen into a plate shape.

In S13-3, continuously from the above-described main firing, the above-described composite body is subjected to rapid cooling from a temperature T₁ of 200° C. or higher to a temperature T₂ of 100° C. or lower (temperature decrease speed: 20° C./min or higher). The above-described preliminary firing and main firing are performed, for example, inside a heating furnace. In step S13-3, for example, after the main firing of the composite body is performed inside a heating furnace, the composite body is cooled to an arbitrary temperature T₁ of 200° C. or higher inside the heating furnace, and after this temperature Ti is reached, the fired product is taken out of the heating furnace and subjected to rapid cooling to an arbitrary temperature T₂ of 100° C. or lower outside the furnace. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower, or may be a cooling end temperature. In a predetermined temperature range from the temperature T₁ to the temperature T₂, moisture is likely to enter between layers of the P2-type structure due to atomic vibration, molecular motion, etc. When cooling the composite body after the main firing (the Na-containing oxide having the P2-type structure), shortening the time of remaining in such a temperature range in which moisture is likely to enter (i.e., performing rapid cooling) can presumably reduce the amount of entry of moisture between the layers of the P2-type structure. In this respect, in step S13-3, when cooling the composite body after the main firing, the composite body is let cool from the arbitrary temperature T₁ of 200° C. or higher to the arbitrary temperature T₂ of 100° C. or lower, for example, in a dry atmosphere outside the furnace. Thus, the cooling speed from the temperature T₁ to the temperature T₂ becomes high (e.g., 20° C./min or higher), so that moisture is less likely to enter between the layers of the P2-type structure, and collapse of the P2-type structure etc. can be mitigated. As a result, in S2, Na ions can be efficiently exchanged with Li ions.

By S13, the Na-containing oxide having the P2-type structure and having a predetermined chemical composition can be manufactured. The Na-containing oxide includes at least, as constituent elements, at least one transition metal element among Mn, Ni, and Co, and Na and O. In particular, when at least Na, Mn, at least either Ni or Co, and O are included as constituent elements, particularly when at least Na, Mn, Ni, Co, and O are included as constituent elements, the performance of the positive electrode active material is likely to become even more higher. The Na-containing oxide may have a chemical composition represented by Na_{c}Mnₓ₋ₚNi_{y-q}Co_{z-r}M_{p+q+r}O₂. Here, 0<c<1.00, x+y+z=1, and 0≤p+q+r<0.17 hold true. M is at least one type of element selected from B, Mg, Al, K, Ca, Ti, V. Cr, Fe, Cu, Zn, Ga, Ge, Sr, Y, Zr, Nb, Mo, and W. When the Na-containing oxide has such a chemical composition, the P2-type structure is likely to be further maintained. In the above chemical composition, the number of c is larger than 0 and may be 0.10 or larger, 0.20 or larger, 0.30 or larger, 0.40 or larger, 0.50 or larger, or 0.60 or larger, and is smaller than 1.00 and may be 0.90 or smaller, 0.80 or smaller, or 0.70 or smaller. The number of x is 0 or larger and may be 0.10 or larger, 0.20 or larger, 0.30 or larger, 0.40 or larger, or 0.50 or larger, and is 1.00 or smaller and may be 0.90 or smaller, 0.80 or smaller, 0.70 or smaller, 0.60 or smaller, or 0.50 or smaller. The number of y is 0 or larger and may be 0.10 or larger or 0.20 or larger, and is 1.00 or smaller and may be 0.90 or smaller, 0.80 or smaller, 0.70 or smaller, 0.60 or smaller, 0.50 or smaller, 0.40 or smaller, 0.30 or smaller, or 0.20 or smaller. The number of z is 0 or larger and may be 0.10 or larger, 0.20 or larger, or 0.30 or larger, and is 1.00 or smaller and may be 0.90 or smaller, 0.80 or smaller, 0.70 or smaller, 0.60 or smaller, 0.50 or smaller, 0.40 or smaller, or 0.30 or smaller. The element M contributes only a little to charging and discharging. In this respect, when the number of p+q+r is smaller than 0.17 in the above chemical composition, a high charging-discharging capacity is likely to be secured. The number of p+q+r may be 0.16 or smaller, 0.15 or smaller, 0.14 or smaller, 0.13 or smaller, 0.12 or smaller, 0.11 or smaller, or 0.10 or smaller. On the other hand, when the element M is included, the P2-type structure or the O2-type structure is likely to stabilize. In the above chemical composition, the number of p+q+r is 0 or larger and may be 0.01 or larger, 0.02 or larger, 0.03 or larger, 0.04 or larger, 0.05 or larger, 0.06 or larger, 0.07 or larger, 0.08 or larger, 0.09 or lager, or 0.10 or larger. While the number of the components of O is almost 2, it is not limited to exact 2.0 and is indefinite.

### 2.2 S2

In S2, at least some of Na ions of the Na-containing oxide obtained by S1 are exchanged with Li ions to obtain a Li-containing oxide having the O2-type structure, the O6-type structure, and the T #2-type structure. For the ion exchange, for example, there is a method that uses an aqueous solution including lithium halide, and a method that uses a mixture of lithium halide and another lithium salt (e.g., molten salt). From the viewpoint that the P2-type structure is prone to collapse due to entry of water and the viewpoint of crystallizability, of these two methods, the method using molten salt is preferable. Specifically, at least some of Na ions of the Na-containing oxide can be replaced with Li ions by ion exchange, by mixing the above-described Na-containing oxide having the P2-type structure and the molten salt together and heating the mixture to a temperature equal to or higher than the melting point of the molten salt. It is preferable that the lithium halide constituting part of the molten salt be at least one of lithium chloride, lithium bromide, and lithium iodide. It is preferable that the other lithium salt constituting part of the molten salt be lithium nitrate. When molten salt is used, the melting point becomes lower than when lithium halide or other lithium salt is used alone, which allows ion exchange at a lower temperature. The temperature during the ion exchange may be, for example, equal to or higher than the melting point of the above-described molten salt, and may be 600° C. or lower, 500° C. or lower, 400° C. or lower, or 300° C. or lower. If the temperature during the ion exchange is too high, instead of the O2-type structure, the O3-type structure that is a stable phase is likely to form. On the other hand, from the viewpoint of shortening the time taken for the ion exchange, the higher the temperature during the ion exchange, the better.

### 3. Electrode

An electrode according to one embodiment includes the above-described electrode active material of this disclosure. Ingredients included in the electrode other than the electrode active material are not particularly limited and can be determined as appropriate according to the intended performance. The electrode according to one embodiment may include the above-described electrode active material of this disclosure, and at least one type among an electrolyte, a conduction agent, and a binder. The electrode according to one embodiment may optionally include other additives. The content of each of the active material, the electrolyte, the conduction agent, the binder, etc. in the electrode can be determined as appropriate according to the intended battery performance. For example, in the case where the electrode includes a current collector and an active material layer, the content of the electrode active material may be 40 mass % or higher and lower than 100 mass %, with an entire solid content in the active material layer as 100 mass %.

### 3.1 Active Material

The active material included in the electrode may be composed only of the above-described electrode active material of this disclosure, or may include, in addition to this electrode active material, an active material other than that (another active material). From the viewpoint of further enhancing the effect of the technology of this disclosure, the ratio of the other active material in the entire active material included in the electrode may be low. For example, with the entire active material included in the electrode as 100 mass %, the content of the above-described electrode active material of this disclosure may be 50 mass % or higher and 100 mass % or lower, 60 mass % or higher and 100 mass % or lower, 70 mass % or higher and 100 mass % or lower, 80 mass % or higher and 100 mass % or lower, 90 mass % or higher and 100 mass % or lower, 95 mass % or higher and 100 mass % or lower, or 99 mass % or higher and 100 mass % or lower. Any commonly known active materials can be adopted as other active materials that can be included in the electrode.

### 3.2 Electrolyte

The electrode can include an electrolyte along with the above-described electrode active material. The electrolyte that can be included in the electrode may be a solid electrolyte, or may be a liquid electrolyte, or may be a combination of the two. For the solid electrolyte, a commonly known solid electrolyte for a battery can be used. The solid electrolyte may be an inorganic solid electrolyte or may be an organic polymer electrolyte. In particular, an inorganic solid electrolyte is excellent in ion conductivity and heat resistance. Examples of inorganic solid electrolytes include an oxide solid electrolyte, a sulfide solid electrolyte, and an ion-binding inorganic solid electrolyte. In particular, when the electrode includes a sulfide solid electrolyte as a solid electrolyte, higher performance is likely to be secured. The sulfide solid electrolyte may include, for example, at least Li, S. and P as constituent elements. Or the electrode may include, as a solid electrolyte, an ion-binding solid electrolyte, and may include a solid electrolyte that includes, for example, at least Li, Y, and halogen (at least one of Cl, Br, I, and F) as constituent elements. The solid electrolyte may be amorphous or may be a crystal. The solid electrolyte may have a particulate shape. An average particle diameter (D50) of the solid electrolyte may be, for example, 10 nm or larger and 10 μm or smaller. Only one type of solid electrolyte may be used alone, or two or more types may be used in combination. A liquid electrolyte (electrolytic solution) is a liquid including lithium ions as carrier ions. The electrolytic solution may be an aqueous electrolytic solution or may be a non-aqueous electrolytic solution. The composition of the electrolytic solution may be the same as a commonly known composition of an electrolytic solution of a lithium-ion battery. The electrolytic solution may be one obtained by dissolving lithium salt in water or a non-aqueous solvent. Examples of non-aqueous solvents include various carbonate-based solvents. Examples of lithium salts include lithium amide salt and LiPF₆.

### 3.3 Conduction Agent

Examples of the conduction agent that can be included in the electrode include carbon materials, such as vapor-grown carbon fiber (VGCF), acetylene black (AB), ketjen black (KB), carbon nanotube (CNT), and carbon nanofiber (CNF), and metal materials, such as nickel, titanium, aluminum, and stainless steel. The conduction agent may have, for example, a particulate shape or a fiber shape, and the size thereof is not particularly limited. Only one type of conduction agent may be used alone, or two or more types may be used in combination.

### 3.4 Binder

Examples of the binder that can be included in the electrode include a butadiene rubber (BR)-based binder, a butylene rubber (IIR)-based binder, an acrylate-butadiene rubber (ABR)-based binder, a styrene-butadiene rubber (SBR)-based binder, a polyvinylidene fluoride (PVdF)-based binder, a polytetrafluoroethylene (PTFE)-based binder, and a polyimide (PI)-based binder. Only one type of binder may be used alone, or two or more types may be used in combination.

### 3.5 Others

Other than the above-described ingredients, the electrode may include various additives. Examples are a dispersant and a lubricant.

### 4. Battery

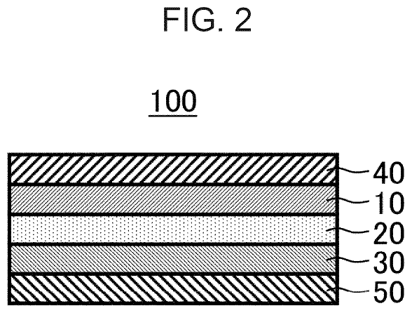

The electrode active material of this disclosure can be adopted as, for example, a positive electrode active material of a battery. As shown in FIG. 2, a battery 100 according to one embodiment has a positive electrode active material layer 10, an electrolyte layer 20, and a negative electrode active material layer 30. The positive electrode active material layer 10 includes the above-described electrode active material of this disclosure.

### 4.1 Positive Electrode Active Material Layer

The positive electrode active material layer 10 includes at least the above-described electrode active material of this disclosure, and may further optionally include an electrolyte, a conduction agent, a binder, etc. The shape of the positive electrode active material layer 10 is not particularly limited, and the positive electrode active material layer 10 may be, for example, of a sheet shape having a substantially planar surface. The thickness of the positive electrode active material layer 10 is not particularly limited, and may be, for example, 0.1 μm or larger or 1 μm or larger, and may be 2 mm or smaller or 1 mm or smaller.

### 4.2 Electrolyte Layer

The electrolyte layer 20 is disposed between the positive electrode active material layer 10 and the negative electrode active material layer 30. The electrolyte layer 20 includes at least an electrolyte. The electrolyte layer 20 may include at least either a solid electrolyte or a liquid electrolyte, and may further optionally include a binder etc. The contents of the electrolyte, the binder, etc. in the electrolyte layer 20 are not particularly limited. Or the electrolyte layer 20 may have a separator or the like for holding a liquid electrolyte and preventing contact with the positive electrode active material layer 10 and the negative electrode active material layer 30. The thickness of the electrolyte layer 20 is not particularly limited, and may be, for example, 0.1 μm or larger or 1 μm or larger, and may be 2 mm or smaller or 1 mm or smaller.

The electrolyte that is included in the electrolyte layer 20 can be selected as appropriate from the electrolytes (the solid electrolytes and/or the liquid electrolytes) that were given as examples of the electrolyte that can be included in the above-described positive electrode active material layer 10 (electrode composite material). The binder that can be included in the electrolyte layer 20 can also be selected as appropriate from the binders that were given as examples of the binder that can be included in the above-described positive electrode active material layer. One type each of the electrolyte and the binder may be used alone, or two or more types may be used in combination. The separator may be any separator that is usually used in batteries, and examples include those made of resin, such as polyethylene (PE), polypropylene (PP), polyester, or polyamide. The separator may have a single-layer structure or may have a multi-layer structure. Examples of the separator with a multi-layer structure include a separator with a PE/PP double-layer structure, and a separator with a PP/PE/PP or PE/PP/PE three-layer structure. The separator may be one formed by non-woven fabric, such as cellulose non-woven fabric, resin non-woven fabric, or glass fiber non-woven fabric.

### 4.3 Negative Electrode Active Material Layer

The negative electrode active material layer 30 includes at least a negative electrode active material. The negative electrode active material layer 30 may optionally include an electrolyte, a conduction agent, a binder, various additives, etc. The content of each ingredient in the negative electrode active material layer 30 can be determined as appropriate according to the intended battery performance. For example, with an entire solid content in the negative electrode active material layer 30 as 100 mass %, the content of the negative electrode active material may be 40 mass % or higher, 50 mass % or higher, 60 mass % or higher, or 70 mass % or higher, and may be 100 mass % or lower, lower than 100 mass %, 95 mass % or lower, or 90 mass % or lower. Or with the entire negative electrode active material layer 30 as 100 vol %, the negative electrode active material, and optionally an electrolyte, a conduction agent, and a binder may be contained 85 vol % or more, 90 vol % or more, or 95 vol % or more in total, and the rest may be voids or other ingredients. The shape of the negative electrode active material layer 30 is not particularly limited, and may be, for example, a sheet shape having a substantially planar surface. The thickness of the negative electrode active material layer 30 is not particularly limited, and may be, for example, 0.1 μm or larger, 1 μm or larger, 10 μm or larger, or 30 μm or larger, and may be 2 mm or smaller, 1 mm or smaller, 500 μm or smaller, or 100 μm or smaller.

For the negative electrode active material, any active materials that are commonly known as negative electrode active materials for batteries can be adopted. Of commonly known active materials, various materials of which the potential for storing and releasing carrier ions (charging-discharging potential) is a less-noble potential compared with that of the above-described positive electrode active material can be adopted. For example, silicon-based active materials, such as Si, Si alloy, and silicon oxide; carbon-based active materials, such as graphite and hard carbon; various oxide-based active materials, such as lithium titanate; and metallic lithium and lithium alloy can be adopted. In particular, when the negative electrode active material layer 30 includes Si as a negative electrode active material, the performance of the battery 100 is likely to be enhanced. Only one type of negative electrode active material may be used alone, or two or more types may be used in combination. The shape of the negative electrode active material may be any shape that is a common shape for negative electrode active materials of batteries. For example, the negative electrode active material may have a particulate shape. The negative electrode active material particles may be primary particles, or may be secondary particles into which a plurality of primary particles has aggregated. An average particle diameter (D50) of the negative electrode active material particles may be, for example, 1 nm or larger, 5 nm or larger, or 10 nm or larger, or may be 500 μm or smaller, 100 μm or smaller, 50 μm or smaller, or 30 μm or smaller. Or the negative electrode active material may have a sheet shape (a foil shape, a film shape) like a lithium foil etc. That is, the negative electrode active material layer 30 may be formed by a sheet of a negative electrode active material.

Examples of the electrolyte that can be included in the negative electrode active material layer 30 include the above-described solid electrolytes and liquid electrolytes, and combinations thereof. The conduction agent that can be included in the negative electrode active material layer 30 can be selected as appropriate, for example, from the conduction agents that were given as examples of the conduction agent that can be included in the above-described positive electrode active material layer 10 (electrode composite material 5). The binder that can be included in the negative electrode active material layer 30 can be selected as appropriate, for example, from the binders that were given as examples of the binder that can be included in the above-described positive electrode active material layer 10 (electrode composite material 5). One type each of the electrolyte, the conduction agent, and the binder may be used alone, or two or more types may be used in combination.

### 4.4 Positive Electrode Current Collector

As shown in FIG. 2, the battery 100 may include a positive electrode current collector 40 that comes into contact with the positive electrode active material layer 10. For the positive electrode current collector 40, any common positive electrode current collectors of batteries can be adopted. The positive electrode current collector 40 may have at least one type of shape selected from a foil shape, a plate shape, a mesh shape, a perforated metal shape, a foaming body shape, etc. The positive electrode current collector 40 may be formed by a metal foil or a metal mesh. In particular, a metal foil is excellent in handleability etc. The positive electrode current collector 40 may be formed by a plurality of foils. The metal composing the positive electrode current collector 40 may be at least one type selected from Cu, Ni, Cr, Au, Pt, Ag, Al, Fe, Ti, Zn, Co, V, Mg, Pb, Ge, In, Sn, Zr, stainless steel, etc. In particular, from a viewpoint such as securing oxidation resistance, the positive electrode current collector 40 may include A1. The positive electrode current collector 40 may have some kind of coating layer for purposes such as adjusting the resistance. For example, the positive electrode current collector 40 may have a carbon coating layer. The positive electrode current collector 40 may be a metal foil or a substrate which is plated with the aforementioned metal or on which the aforementioned metal is deposited. In the case where the positive electrode current collector 40 is formed by a plurality of metal foils, some kind of layer may be provided between the plurality of metal foils. The thickness of the positive electrode current collector 40 is not particularly limited. For example, the thickness may be 0.1 μm or larger or 1 μm or larger, and may be 1 mm or smaller or 100 μm or smaller.

### 4.5 Negative Electrode Current Collector

As shown in FIG. 2, the battery 100 may include a negative electrode current collector 50 that comes into contact with the negative electrode active material layer 30. For the negative electrode current collector 50, any common negative electrode current collectors of batteries can be adopted. The negative electrode current collector 50 may have a foil shape, a plate shape, a mesh shape, a perforated metal shape, a foaming body shape, etc. The negative electrode current collector 50 may be a metal foil or a metal mesh, or may be a carbon sheet. In particular, a metal foil is excellent in handleability etc. The negative electrode current collector 50 may be formed by a plurality of foils or sheets. The metal composing the negative electrode current collector 50 may be at least one type selected from Cu, Ni, Cr, Au, Pt, Ag, Al, Fe, Ti, Zn, Co, V, Mg, Pb, Ge, In, Sn, Zr, stainless steel, etc. In particular, from the viewpoint of securing reduction resistance and the viewpoint of the difficulty of alloying with lithium, the negative electrode current collector 50 may include at least one type of metal selected from Cu, Ni, and stainless steel. The negative electrode current collector 50 may have some kind of coating layer for purposes such as adjusting the resistance. For example, the negative electrode current collector 50 may have a carbon coating layer. The negative electrode current collector 50 may be an aluminum foil having a carbon coating layer. The negative electrode current collector 50 may be a metal foil or a substrate which is plated with the aforementioned metal or on which the aforementioned metal is deposited. In the case where the negative electrode current collector 50 is formed by a plurality of metal foils, some kind of layer may be provided between the plurality of metal foils. The thickness of the negative electrode current collector 50 is not particularly limited. For example, the thickness may be 0.1 μm or larger or 1 μm or larger, and may be 1 mm or smaller or 100 μm or smaller.

### 4.6 Other Components

Other than the above-described components, the battery 100 may include components that are common among batteries. Examples include tabs and terminals. The battery 100 may be a battery in which the above-described components are housed inside an outer casing. For the outer casing, any outer casing that is commonly known as an outer casing of batteries can be adopted. A plurality of batteries 100 may be optionally electrically connected to one another or optionally stacked to constitute a battery pack. In this case, this battery pack may be housed inside a commonly known battery case. Examples of the shape of the battery 100 include a coin shape, a laminate shape, a cylindrical shape, and a rectangular shape. The battery 100 may be a secondary battery.

The battery 100 can be manufactured by applying a commonly known method, except that the above-described specific electrode active material is used. For example, the battery 100 can be manufactured as follows. However, the manufacturing method of the battery 100 is not limited to the following method, and, for example, each layer may be formed by dry forming etc.
(1) The electrode active material etc. constituting the positive electrode active material layer are dispersed in a solvent to obtain slurry for the positive electrode layer. The solvent used in this case is not particularly limited, and water or various organic solvents can be used. Using a doctor blade etc., the slurry for the positive electrode layer is applied to the surface of the positive electrode current collector and then dried to form a positive electrode active material layer on the surface of the positive electrode current collector. Thus, a positive electrode is produced.
(2) The negative electrode active material etc. constituting the negative electrode active material layer are dispersed in a solvent to obtain slurry for the negative electrode layer. The solvent used in this case is not particularly limited, and water or various organic solvents can be used. Using a doctor blade etc., the slurry for the negative electrode layer is applied to the surface of the negative electrode current collector and then dried to form a negative electrode active material layer on the surface of the negative electrode current collector. Thus, a negative electrode is produced.
(3) The layers are stacked so as to sandwich the electrolyte layer (a solid electrolyte layer or a separator) by the negative electrode and the positive electrode to obtain a stack having the negative electrode current collector, the negative electrode active material layer, the electrolyte layer, the positive electrode active material layer, and the positive electrode current collector in this order. As necessary, other members, such as terminals, are attached to the stack.
(4) The stack is housed in a battery case, and in the case of an electrolytic solution battery, the battery case is filled with an electrolytic solution, and the stack is sealed inside the battery case such that the stack is immersed in the electrolytic solution. Thus, a secondary battery is produced. In the case of an electrolytic solution battery, the negative electrode active material layer, the separator, and the positive electrode active material layer may be soaked with the electrolytic solution at the stage of (3) described above.

### 5. Vehicle

By using the electrode active material, the battery of this disclosure has excellent rate characteristics. Such a battery can be suitably used in, for example, at least one type of vehicle selected from a hybrid electric vehicle (HEV), a plug-in hybrid electric vehicle (PHEV), and a battery electric vehicle (BEV). Thus, the technology of this disclosure has also an aspect as a vehicle having a battery, in which the battery has a positive electrode active material layer, an electrolyte layer, and a negative electrode active material layer, with the positive electrode active material layer including the above-described electrode active material of this disclosure.

While one embodiment of the electrode active material etc. has been described above, other than the above-described embodiment, various changes can be made to the technology of this disclosure within such a range that no departure is made from the gist thereof. In the following, the technology of this disclosure will be described in further detail while showing examples of implementation, but the technology of this disclosure is not limited to the following examples of implementation.

### 1. Production of Electrode Active Material

### 1.1 Example 1

### 1.1.1 Production of Precursor

(1) MnSO₄·5H₂O, NiSO₄·6H₂O, CoSO₄·7H₂O were weighed to an intended composition ratio (Mn:Ni:Co=5:2:3) and dissolved in distilled water to a concentration of 1.2 mol/L to obtain a first solution. In a separate container, Na₂CO₃ was dissolved in distilled water to a concentration of 1.2 mol/L to obtain a second solution.
(2) 1000 mL of pure water was put in a reaction vessel (with a baffle plate), into which 500 mL of the first solution and 500 mL of the second solution were each dripped at a speed of about 4 mL/min.
(3) After the dripping ended, the mixture was stirred at room temperature at a stirring speed of 150 rpm for one hour to obtain a product.
(4) The product was washed with pure water and separated into a solid and a liquid by a centrifugal separator, and a precipitate was collected.
(5) The obtained precipitate was dried overnight at 120° C. and pulverized in a mortar, and was then separated into coarse particles and fine particles by airflow classification. Then, the fine particles were removed, and the coarse particles as the precursor particles were obtained.

### 1.1.2 Production of Composite Body

(1) Na₂CO₃ and distilled water were weighed to 1150 g/L and then stirred together using a stirrer until the former is completely dissolved to produce an aqueous solution of Na₂CO₃.

(2) The above-described aqueous solution of Na₂CO₃ and the above-described precursor particles were weighed and mixed so as to have a composition Na_{0.8}Mn_{0.5}Ni_{0.2}Co_{0.3}O₂ after firing, to be described later, to obtain slurry.
(3) This slurry was flash-dried by spray drying to obtain a composite body. Specifically, using a spray drying device DL410, this slurry was flash-dried under the conditions of slurry feed speed: 30 mL/min, inlet temperature: 200° C., circulation air volume: 0.8 m³/min, and spraying pressure: 0.3 MPa to cover the surfaces of the precursor particles with Na₂CO₃ and obtain a composite body.

### 1.1.3 Firing of Composite Body

The composite body was put in an alumina crucible and firing was performed in an ambient air atmosphere to obtain a Na-containing oxide having the P2-type structure. The firing conditions are the following (1) to (7):
(1) Installing the alumina crucible containing the above-described composite body in a heating furnace having an ambient air atmosphere.
(2) Raising the temperature inside the heating furnace from room temperature (25° C.) to 600° C. in 115 minutes.
(3) Holding the inside of the heating furnace at 600° C. for 360 minutes to perform preliminary firing.
(4) After the preliminary firing, raising the temperature inside the heating furnace to 900° C., and then holding the inside of the heating furnace at 900° C. for 60 minutes to perform main firing.
(5) After the main firing, lowering the temperature inside the heating furnace from the main firing temperature to 250° C., and then taking the alumina crucible out of the heating furnace at 250° C. and letting it cool in a dry atmosphere outside the furnace so as to reach 25° C. in ten minutes.

The fired product after being let cool was pulverized using a mortar in a dry atmosphere to obtain Na-containing oxide particles having the P2-type structure (P2-type particles).

### 1.1.4 Ion Exchange

(1) LiNO₃ and LiCl were weighed to a molar ratio of 50:50 and mixed with the above-described P2-type particles to such a molar ratio that the amount of Li became ten times the minimum amount required for ion exchange. Thus, a mixture was obtained.
(2) Using an alumina crucible, ion exchange was performed in an ambient air atmosphere at 280° C. for one hour to obtain a product including a Li-containing oxide.
(3) Salt remaining in the product was washed with pure water, and the product was separated into a solid and a liquid by vacuum filtration to obtain a precipitate.
(4) The obtained precipitate was dried overnight at 120° C. to obtain electrode active material particles according to Example 1. These electrode active material particles were a Li-containing oxide represented by Li_{0.6}3Mn_{0.5}Ni_{0.2}Co_{0.3}O₂. Further, when crystal phases included in the electrode active material particles were checked by an XRD, the electrode active material particles did not have the O3-type structure and had at least the O2-type structure.

### 1.2 Example 2

An electrode active material was produced in the same manner as in Example 1, except that the firing temperature of the composite body was changed from 900° C. to 800° C. These electrode active material particles were a Li-containing oxide represented by Li_{0.6}2Mn_{0.5}Ni_{0.2}Co_{0.3}O₂. Further, when crystal phases included in the electrode active material particles were checked by an XRD, the electrode active material particles did not have the O3-type structure and had at least the O2-type structure.

### 1.3 Comparative Example 1

As the precursor particles, fine particles instead of coarse particles were adopted. These fine particles and Na₂CO₃ powder were weighed to Na_{0.8}Mn_{0.5}Ni_{0.2}Co_{0.3}O₂ and mixed in a mortar to obtain a composite body. Using this composite body, firing and ion exchange were performed in the same manner as in Example 1 to produce an electrode active material. The electrode active material particles were a Li-containing oxide represented by Li_{0.64}Mn_{0.5}Ni_{0.2}Co_{0.3}O₂. Further, when crystal phases included in the electrode active material particles were checked by an XRD, the electrode active material particles did not have the O3-type structure and had at least the O2-type structure.

### 1.4 Comparative Example 2

An electrode active material was produced in the same manner as in Comparative Example 1, except that the firing temperature of the composite body was changed from 900° C. to 800° C. The electrode active material particles were a Li-containing oxide represented by Li_{0.6}3Mn_{0.5}Ni_{0.2}Co_{0.3}O₂. Further, when crystal phases included in the electrode active material particles were checked by an XRD, the electrode active material particles did not have the O3-type structure and had at least the O2-type structure.

### 1.5 Comparative Example 3

An electrode active material was produced in the same manner as in Example 1, except that the firing temperature of the composite body was changed from 900° C. to 1000° C. The electrode active material particles were a Li-containing oxide represented by Li_{0.6}2Mn_{0.5}Ni_{0.2}Co_{0.3}O₂. Further, when crystal phases included in the electrode active material particles were checked by an XRD, the electrode active material particles did not have the O3-type structure and had at least the O2-type structure.

### 2. ACOM-STEM Measurement

An ACOM-STEM measurement was performed on a cross-section of each electrode active material, and the area ratio of each of the O2-type structure, the O6-type structure, and the T #2-type structure in the cross-section was calculated. Identification of crystal phases was performed by comparing an electron diffraction pattern at each measurement point and known crystal structure information. In this measurement, a beam diameter of about 1.5 nm was adopted, and therefore the O6-type structure of which the lattice constant exceeds 20 nm may be calculated as the O3-type structure. On the other hand, from the result of the XRD, the content ratio of the O3-type structure in each electrode active material is 0% as described above. Therefore, in calculating the area ratio, a part where the O3 structure was determined to be present in the ACOM-STEM measurement was regarded as a part where the O6-type structure was present.

### 3. Production of Coin Cell

A coin cell (CR2032) was produced using each electrode active material. The production procedure of the coin cell is as follows:
(1) The above-described electrode active material, acetylene black (AB) as a conduction agent, and polyvinylidene fluoride (PVdF) as a binder were weighed to a mass ratio of electrode active material:AB:PVdF=85:10:5 and dispersed and mixed in N-methyl-2-pyrolidone to obtain slurry of a positive electrode composite material. The slurry of the positive electrode composite material was applied to an aluminum foil and vacuum-dried overnight at 120° C. to obtain a positive electrode that is a stack of a positive electrode active material layer and a positive electrode current collector.
(2) LiPF₆ was dissolved at a 1 M concentration in a mixed solvent of trifluoropropylene carbonate (TFPC) and trifluoroethyl methyl carbonate (TFEMC) mixed together at a ratio of TFPC:TFEMC=30 vol %:70 vol % to obtain an electrolytic solution.
(3) A metallic lithium foil was prepared as a negative electrode.
(4) Using the positive electrode, the electrolytic solution, and the negative electrode, a coin cell (CR2032) was produced.

### 4. Evaluation of Charge-Discharge Characteristics of Coin Cell

Each coin cell was charged and discharged in a constant-temperature bath held at 25° C., in a voltage range of 2.0 to 4.8 V at 0.1C rate (1C=220 mA/g) to measure the discharge capacity at 0.1C. Subsequently, after being charged at 0.1C rate, the coin cell was discharged at 3C to measure the discharge capacity at 3C. The rate characteristics of the coin cell were evaluated by obtaining the ratio of the discharge capacity at 3C to the discharge capacity at 0.1C.

### 5. Evaluation Result

Table 1 below shows, for each electrode active material, “A1: the area ratio of the O2-type structure in the cross-section of the electrode active material,” “A2: the area ratio of the O6-type structure in the cross-section,” “A3: the area ratio of the T #2-type structure in the cross-section,” “A2/A1,” and “A3/A1.” Further, for each coin cell, “0.1C discharge capacity,” “3C discharge capacity,” and “rate characteristics (3C discharge capacity/0.1C discharge capacity)” are shown.

TABLE 1

| | | | | | | 0.1 C | 3 C | |
|---|---|---|---|---|---|---|---|---|
| | | | | | | discharge | discharge | Rate |
| | A1 | A2 | A3 | A2/A1 | A3/A1 | capacity | capacity | characteristics |
| Example 1 | 0.204 | 0.563 | 0.233 | 2.76 | 1.14 | 234 | 203 | 0.87 |
| Example 2 | 0.024 | 0.934 | 0.042 | 38.92 | 1.75 | 234 | 205 | 0.88 |
| Comparative | 0.609 | 0.230 | 0.161 | 0.38 | 0.26 | 238 | 201 | 0.84 |
| Example 1 | | | | | | | | |
| Comparative | 0.267 | 0.607 | 0.126 | 2.27 | 0.47 | 237 | 198 | 0.84 |
| Example 2 | | | | | | | | |
| Comparative | 0.021 | 0.938 | 0.041 | 44.67 | 1.95 | 234 | 193 | 0.82 |
| Example 3 | | | | | | | | |

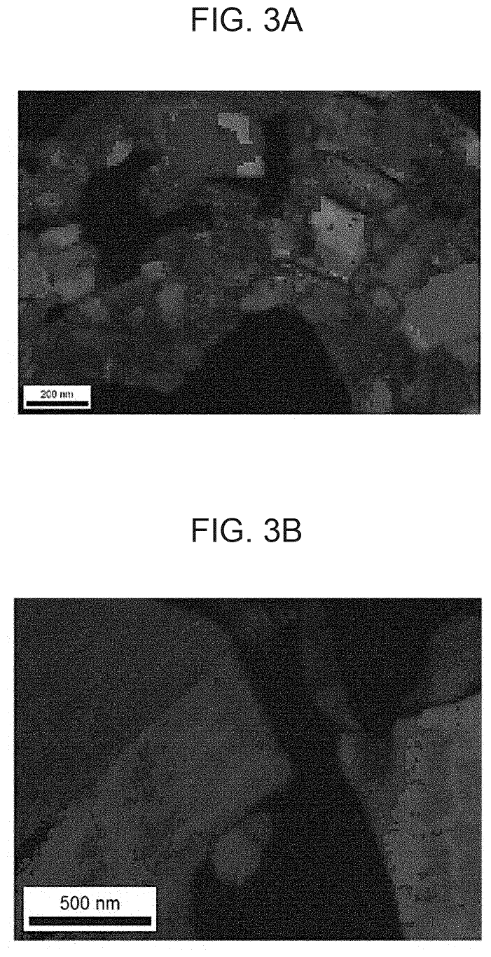

FIG. 3A shows the result of the ACOM-STEM measurement for the cross-section of the electrode active material according to Example 1. FIG. 3B shows the result of the ACOM-STEM measurement for the cross-section of the electrode active material according to Comparative Example 1.

From the results shown in Table 1 and FIGS. 3A and 3B, it can be seen that the batteries using the electrode active materials according to Examples 1 and 2 in which A2/A1 is within the predetermined range and A3/A1 is also within the predetermined range are superior in rate characteristics to the batteries using the electrode active materials according to Comparative Examples 1 to 3 in which A2/A1 is outside the predetermined range and A3/A1 is also outside the predetermined range.

### 6. Conclusion

From the above results, it can be said that the rate characteristics of a battery can be improved by configuring the battery using an electrode active material meeting the following relationships (1) and (2):
2.30≤A2/A1≤44.00 (1); and
0.50≤A3/A1≤1.90 (2), where:
A1: the area ratio of the O2-type structure in the cross-section of the electrode active material;
A2: the area ratio of the O6-type structure in the cross-section of the electrode active material; and
A3: the area ratio of the T #2-type structure in the cross-section of the electrode active material.

What is claimed is:

1. An electrode active material, wherein the following relationships (1) and (2) are met when a cross-section of the electrode active material is observed:
2.30≤A2/A1≤44.00 (1); and
0.50≤A3/A1≤1.90 (2), where:
A1: an area ratio of an O2-type structure in the cross-section;
A2: an area ratio of an O6-type structure in the cross-section; and
A3: an area ratio of a T #2-type structure in the cross-section.

2. The electrode active material according to claim 1, wherein the electrode active material includes at least one of Ni, Mn, and Co as a constituent element.

3. The electrode active material according to claim 2, wherein the electrode active material has a chemical composition represented by LiₐNa_{b}Mnₓ₋ₚNi_{y-q}Co_{z-r}M_{p+q+r}O₂ (where 0<a≤1.00, 0≤b≤0.20, x+y+z=1, and 0≤p+q+r<0.17 hold true, and the element M is at least one type selected from B, Mg, Al, K, Ca, Ti, V, Cr, Fe, Cu, Zn, Ga, Ge, Sr, Y, Zr, Nb, Mo, and W).

4. An electrode including the electrode active material according to claim 1.

5. A battery having a positive electrode active material layer, an electrolyte layer, and a negative electrode active material layer, wherein the positive electrode active material layer includes the electrode active material according to claim 1.
